(19) United States
(12) Patent Application Publication
(10) Pub. No.: US 2005/0242206 A1
(43) Pub. Date: Nov. 3, 2005

(54) Firefighting nozzle

(76) Inventors: Mark S. Saner, Wooster, OH (US); Kevin J. Petit, Wooster, OH (US)

Correspondence Address: H. Duane Switzer, Jones Day;North Point, 901 Lakeside Avenue, Cleveland, OH, 44114-1190, US

(21) Appl. No.: 11/100,147

(22) Filed: Apr. 6, 2005

Related U.S. Application Data
(63) Continuation-in-part of application No. 09/956,375, filed on Sep. 18, 2001, now Pat. No. 6,877,676.

(51) Int. Cl. A62C 5/02

(52) U.S. Cl. 239/296

(57) ABSTRACT

A firefighting nozzle capable of selectively producing only a solid stream, only a fog pattern or a combination of both. The passage for the fog liquid can be opened to a flushing position for flushing debris therefrom. A solid stream sleeve is removably attached to a nozzle body for allowing discharge of solid streams having different diameters. A valve ball having a ball passageway is configured to provide flow therethrough from a supply passage to an annular discharge passage in one position of said ball in which a solid stream discharge passage is closed by the ball, and to provide flow therethrough from the supply passage to the solid stream discharge passage in another position of said ball.

### RELATED U.S. APPLICATION DATA

This application is a continuation-in-part of U.S. Ser. No. 09/956,375 filed Sep. 18, 2001, now U.S. Pat. No. 6,877,676 issued Apr. 12, 2005.

### BACKGROUND OF THE INVENTION

This application relates to the art of nozzles and, more particularly, to nozzles that are capable of producing a solid stream, a fog pattern or a combination of both. The nozzle of the present application is particularly suited for use in firefighting and will be described with particular reference thereto. However, it will be appreciated that at least certain features of the nozzle may have broader applications and uses.

Nozzles that selectively can produce a solid stream, a fog pattern or a combination of the two cannot easily be converted to produce solid streams of different diameters, are prone to clogging by debris and cannot produce effective or variable fog patterns. It would be desirable to have a combination nozzle that alleviates these deficiencies.

### SUMMARY OF THE INVENTION

A firefighting nozzle of the type described that is capable of producing a solid stream, a fog pattern or both includes a flushing feature for flushing the fog liquid supply passage, a conversion feature for selectively providing solid streams of different diameters, and a feature for providing fog patterns that are both effective and variable. In another arrangement, the nozzle selectively produces either a solid stream or a fog pattern, but not both.

The nozzle of the present application includes a valve ball having primary and secondary flow passages. In one ball position, liquid flows through the primary flow passage to a solid stream passage and out through the secondary flow passage to an annular fog liquid supply passage. In another ball position, the solid stream passage is closed while liquid flows into the secondary flow passage and out the primary flow passage to the annular fog liquid supply passage. In another arrangement, the ball has a single frusto-conical ball passageway centrally located so that the longitudinal axis of the frusto-conical ball passageway passes through the center of the ball.

The nozzle of the present application includes a replaceable solid stream sleeve that is readily replaceable so that solid streams of different diameters and reach can be projected from the nozzle.

In accordance with the present application, a movable discharge sleeve in the passage that supplies fog liquid is movable to a flushing position in which the outlet from the passage is wide open so that debris can be flushed from the passage and outlet.

In accordance with another aspect of the application, a pattern sleeve is adjustable to vary the outward spread of the fog pattern and to bring a turbine ring into action for more thorough dispersal of the fog pattern.

It is a principal object of the present invention to provide improvements to a firefighting nozzle that is capable of producing either a solid stream or a fog pattern and, in one embodiment, a combination of both.

It is another object to provide such a nozzle with a valve ball having a single ball passageway that is configured to provide flow to either a solid stream outlet or to a fog outlet, but not to both.

It is another object of the invention to provide such a nozzle with a valve ball having primary and secondary flow passages for providing both solid stream and fog liquid or only fog liquid in different positions of the ball.

It is another object of the invention to provide such a nozzle with a flushable passage for the fog producing liquid.

It is a further object of the invention to provide such a nozzle having a replaceable solid stream sleeve to enable projection of solid streams having different diameters and reach.

It is also an object of the invention to provide such a nozzle with an adjustable fog pattern and with a dispersible feature for providing high dispersal of the fog liquid.

It is an additional object of the invention to provide such a nozzle that is relatively economical and simple to manufacture, assemble and repair.

### BRIEF DESCRIPTION OF THE DRAWING

FIG. 1 is a side elevational view of a firefighting nozzle in accordance with the present application, and with portions cut-away and in section for clarity of illustration;

FIG. 2 is a partial view similar to FIG. 1 and showing a pattern sleeve in an alternative position;

FIG. 3 is a view similar to FIG. 2 and showing the pattern sleeve in a different position for closing an annular outlet;

FIG. 4 is a view similar to FIG. 3 and showing the pattern sleeve in a clean-out position for flushing an annular passage through which liquid flows for producing fog;

FIG. 5 is a side elevational view of a nozzle body casting used in the firefighting nozzle of FIGS. 1-4.

FIG. 6 is a cross-sectional elevational view taken generally on line 6-6 of FIG. 5;

FIG. 7 is a cross-sectional elevational view taken generally on line 7-7 of FIG. 5;

FIG. 8 is a cross-sectional elevational view taken generally on line 8-8 of FIG. 7;

FIG. 9 is an end elevational view taken generally one line 9-9 of FIG. 1;

FIG. 10 is a top plan view of a ball used in the ball valve of the present application;

FIG. 11 is a side elevational view of the ball of FIG. 10 taken generally on line 11-11 of FIG. 10;

FIG. 12 is a cross-sectional elevational view taken generally on line 12-12 of FIG. 11;

FIG. 13 is a side elevational view of another embodiment;

FIG. 14 is a partial cross-sectional elevational view showing the valve ball within the embodiment of FIG. 13 in a solid stream position;

FIG. 15 is a view similar to FIG. 14, but showing the valve ball in an alternative fog pattern position;

FIG. 16 is a view similar to FIGS. 14 and 15, and showing the valve ball in a closed position;

FIG. 17 is a side elevational view of an outer flat surface on the nozzle body of FIG. 13, and showing an arcuate groove in which a ball rides; and

FIG. 18 is a partial cross-sectional elevation view showing a ball detent carried by the handle of the nozzle of FIG. 13.

### DESCRIPTION OF A REPRESENTATIVE EMBODIMENT

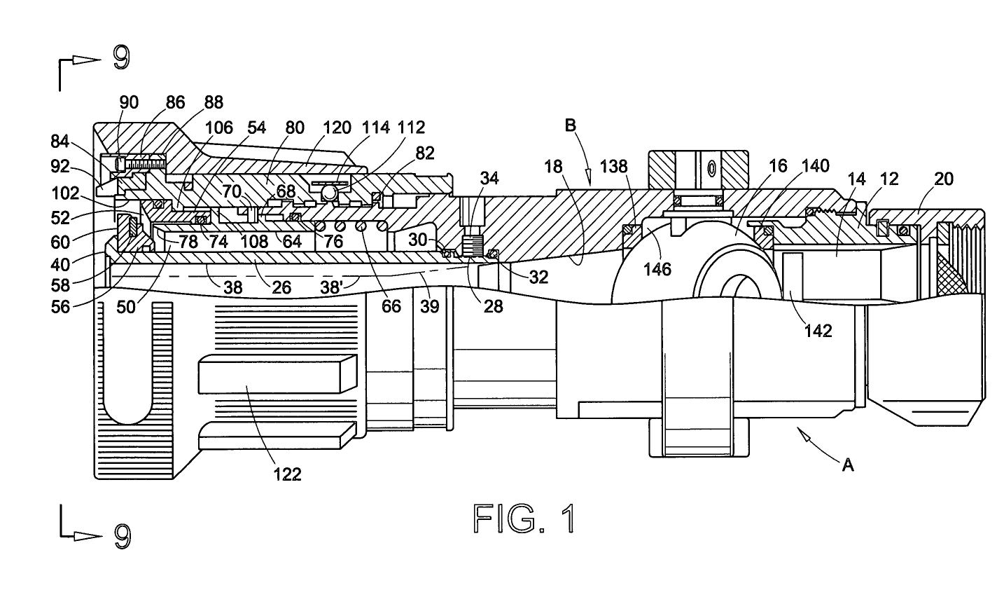

Referring now to the drawing, wherein the showings are for purposes of illustrating representative embodiments of the invention only and not for purposes of limiting same, FIG. 1 shows a nozzle assembly A that includes a one-piece cast nozzle body B.

An inlet adapter 12 is secured to nozzle body B and has a liquid supply passage 14 on the upstream side of ball valve 16. A discharge passage 18 is provided in nozzle body B on the downstream side of ball valve 16. A coupling 20 is attached to inlet adapter 12 for connecting the nozzle assembly to a hose.

A cylindrical solid stream sleeve 26 is removably attached to nozzle body B by way of cooperating external threads on the sleeve and internal threads on the nozzle body as generally indicated at 28. Sealing rings 30, 32 are provided between the sleeve and nozzle body on opposite sides of the cooperating threads. A set screw 34 threaded into a suitable radial tapped hole in nozzle body B is engageable with the threads on solid stream sleeve 26 for releasably locking same in position.

Solid stream sleeve 26 may be provided in a variety of different diameter solid stream passages 38 depending upon the application to be served by the nozzle assembly. As shown in FIG. 9, outer end face 40 of solid stream sleeve 26 has a pair of opposite recesses 42, 44 therein to receive a spanner wrench for rotating the sleeve to install or remove same. By way of example, shadow line 38′ in FIG. 1 represents the inner surface of a different solid stream sleeve having a smaller diameter flow passage. The sleeves with smaller diameter flow passages have an entrance taper as generally indicated at 39 corresponding to the taper of discharge passage 18 while the remainder of the solid stream passage along a major portion of the sleeve length is cylindrical.

An annular discharge passage 50 surrounds solid bore sleeve 26 and has an annular outlet 52 between a throat ring 54 and a baffle ring 56. A gasket 58 is secured between baffle ring 56 and a gasket retainer ring 60. Gasket retainer ring 60 may be considered to be a fixed deflector while throat ring 54 is a movable fog pattern control member.

Throat ring 54 is received on an outer end portion of a discharge sleeve 64 that normally is biased to the left in FIG. 1 by a coil spring 66 to engage discharge sleeve abutment 68 with a stop pin 70 secured to nozzle body B. A sealing ring 74 is provided between throat ring 54 and discharge sleeve 64, and another sealing ring 76 is provided between the rear end portion of discharge sleeve 64 and nozzle body B.

The inner surface of discharge sleeve 64 has an outwardly curved or flared outer end portion 78 leading to annular outlet 52. The opposed surface of gasket retainer 60 likewise is inclined as shown in FIG. 1 to facilitate flow of liquid from annular passage 50 to outlet 52 by providing an annular transition passage for changing the direction of flow.

A pattern sleeve 80 is threaded on nozzle body B for longitudinal movement relative thereto upon rotation of the pattern sleeve. The cooperating inner threads on the pattern sleeve and the external threads on nozzle body B are generally indicated by numeral 82. A turbine ring 84 is rotatably trapped between the outer end of pattern sleeve 80 and a turbine ring retainer 86 attached to an outwardly extending flange 88 on pattern sleeve 80 by plurality of fasteners 90. Turbine ring 84 has a plurality of circumferentially-spaced inclined vanes 92 thereon for providing rotation of turbine ring 84 when liquid strikes vanes 92.

In the position of the pattern sleeve shown in FIG. 1, an inner cylindrical surface 102 at the outer end portion of the pattern sleeve extends well beyond throat ring 54. Therefore, liquid flowing through annular outlet 52 from annular passage 50 strikes inner cylindrical surface 102 to produce an annular solid liquid discharge stream.

Pattern sleeve 80 is rotatable to move same rearwardly along nozzle body B so that the length of inner cylindrical surface 102 extending beyond throat ring 54 becomes progressively smaller. As the length of inner cylindrical surface 102 that extends beyond through ring 54 becomes smaller, the liquid flowing through annular outlet 102 is dispersed outwardly in a progressively wider and more dispersed fog pattern instead of being in a solid annular stream.

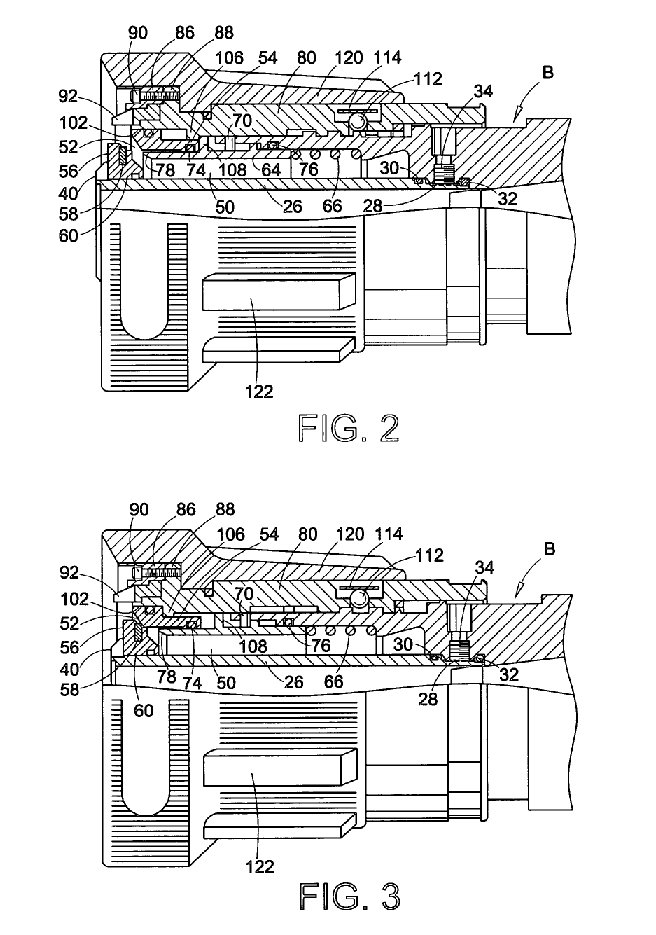

Eventually, as shown in FIG. 2, cylindrical surface 102 is completely retracted clear of annular outlet 52 and vanes 92 on turbine ring 84 become aligned with outlet 52. The liquid striking the vanes causes further dispersal of the liquid and also causes rotation of the turbine ring to further disperse the liquid into a highly scattered fog pattern.

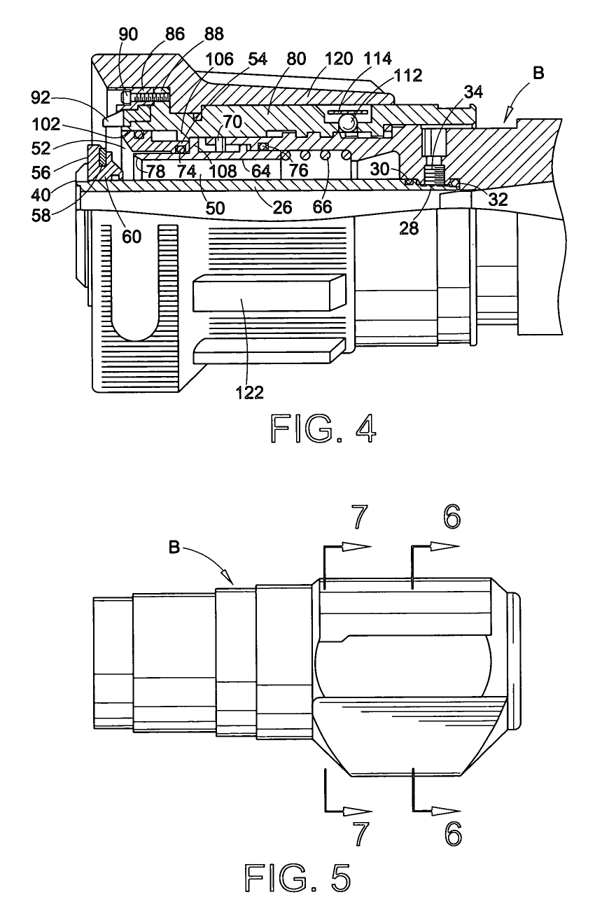

Further rearward movement of pattern sleeve 80 causes an inwardly extending projection 106 on pattern sleeve 80 to engage an outwardly extending projection 108 on discharge sleeve 64 to move same rearwardly to the flushing position shown in FIG. 4 wherein outlet opening 52 is much larger than normal for flushing debris from discharge passage 50 and annular outlet 52.

Movement of pattern sleeve 80 in a direction outwardly along nozzle body B from the position shown in FIG. 1 gradually reduces the size of annular outlet 52 and eventually closes the annular outlet 52 as shown in FIG. 3 by engagement of the inclined outer surface of throat ring 54 with gasket 58.

One or more balls 112 received in a suitable hole in pattern sleeve 80 engage a plurality of circumferentially-spaced detents in the exterior surface of nozzle body B. A spring band 114 extending around the nozzle body biases the ball inwardly into the detents to provide releasable holding of the pattern sleeve in a desired adjusted position and to produce a clicking action when the pattern sleeve is rotated. An elastomeric bumper 120 secured to pattern sleeve 80 has a plurality of circumferentially-spaced outwardly projecting lugs 122 thereon to facilitate gripping of the bumper for rotating same along with pattern sleeve 80.

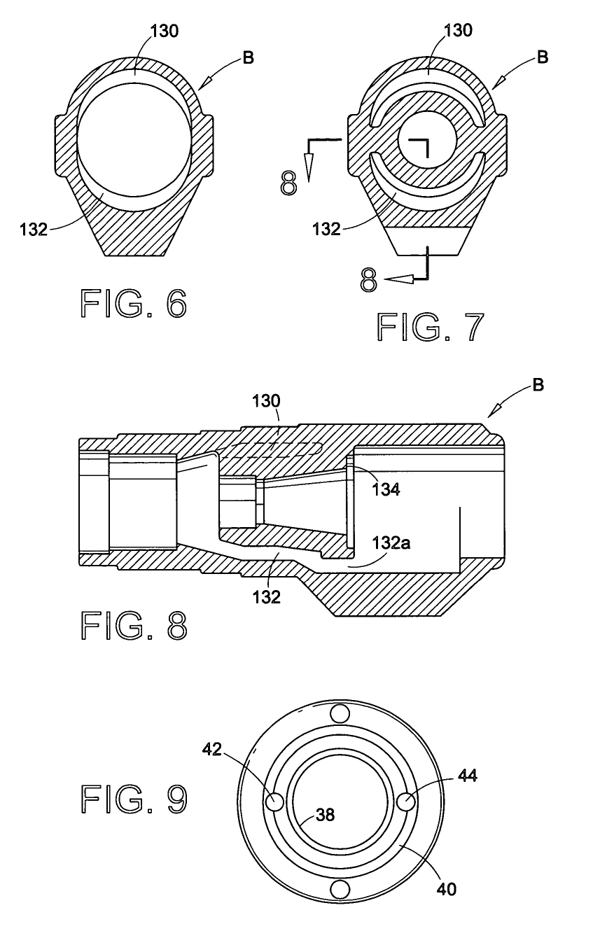

The flow passages within the nozzle body B for supplying liquid to annular passage 50 are shown with reference to FIGS. 5-8. Internal flow passages 130, 132 have inlets on the downstream side of ball valve 16 and only one of such inlets is shown at 132a for flow passage 132. The interior of nozzle body B has a circumferential recess 134 outwardly of inlets 132a as shown in FIG. 8. Recess 134 receives a downstream seal 138 in FIG. 1 on the downstream side of ball valve 16. An upstream ball valve seal 140 is carried by inlet adapter 12. Circumferentially-spaced lateral bypass openings 142 in inlet adapter 12 on the upstream side of ball valve 16 extend radially of the nozzle axis and allow liquid to flow outwardly past upstream seal 140 around the exterior of ball valve 16 through bypass passages 146 to enter the inlets 132a to passages 130, 132 located radially outwardly of ball valve seal 138.

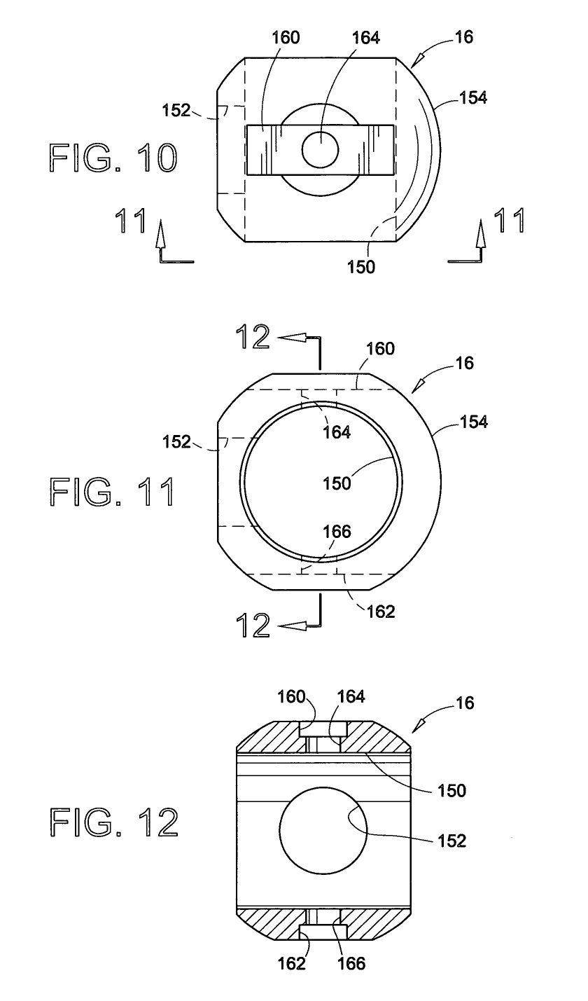

FIGS. 10-12 show generally spherical valve ball 16 having a cylindrical primary flow passage 150 therethrough. A cylindrical secondary flow passage 152 extends through only one side of the ball and intersects primary flow passage 150 at the midpoint thereof. Thus, the ball has three openings on its external surface through which liquid flows. The axes of passages 150, 152 intersect perpendicular to one another.

Primary flow passage 150 is much larger than secondary flow passage 152. By way of example, primary flow passage 150 may have a diameter of around 1.4 inch while secondary flow passage 152 has a diameter of around 0.75 inch.

A spherically curved external surface area 154 on ball 16 is adapted to cooperate with seal 138 of FIG. 1 to close solid stream passage 18.

Grooves 160, 162 and holes 164, 166 in ball 16 are provided for rotatably mounting the ball on the nozzle body and attaching a handle thereto for moving same between alternate positions.

In a combined supply position of ball 16, primary flow passage 150 is aligned with supply and solid stream passages 14, 18, while secondary flow passage 152 communicates between primary flow passage 150 and annular passage 50 by way of bypass passage 146, internal flow passages 130, 132 and inlets 132a in nozzle body B. Annular outlet 52 may be closed so that all of the liquid will be discharged through solid stream passage 18, or may be open to produce fog in combination with the solid stream.

In another position of valve ball 16 that is rotatably displaced 90° from the above described position, secondary flow passage 152 is aligned with supply passage 14 while the opposite open ends of primary flow passage 150 communicate with annular passage 50 by way of bypass passage 146, internal passages 130, 132 and inlets 132a in nozzle body B. In this position of the ball, solid stream passage 18 is closed by cooperation of seal 138 with ball area 154. All of the liquid now is supplied for discharge through annular fog liquid outlet 52.

In the combined supply position of ball 16, liquid flows into one open end of primary flow passage 150 from supply passage 14 and flows out of the other open end of primary flow passage 150 to solid stream passage 18. In this position, liquid flows out of secondary flow passage 152 to bypass passage 146 where it flows through nozzle body internal passages 130, 132 to annular passage 50. Liquid is discharged from annular passage depending on whether annular outlet 52 is open.

In the other position of ball 16, liquid flows into secondary flow passage 152 from supply passage 14 and flows out through the opposite open ends of primary flow passage 150 to bypass passage 146 where it may flow through nozzle body internal passages 130, 132 to annular passage 50. In this position of ball 16, solid stream passage 18 is closed by the ball and liquid will be discharged from annular passage 50 depending on whether annular outlet 52 is open. The discharge pattern from annular outlet 52 is variable by adjustment of pattern sleeve 80.

Bypass passage 146 externally of ball 16 communicates between annular discharge passage 50 and supply passage 14 by way of openings 142 in the supply passage and internal passages 130, 132 in nozzle body B.

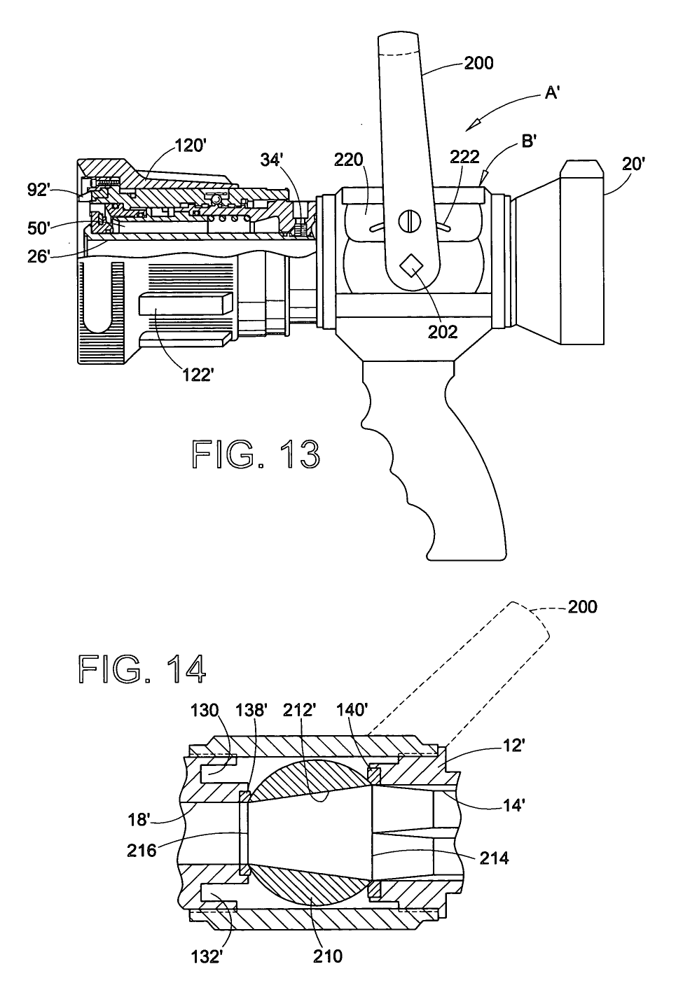

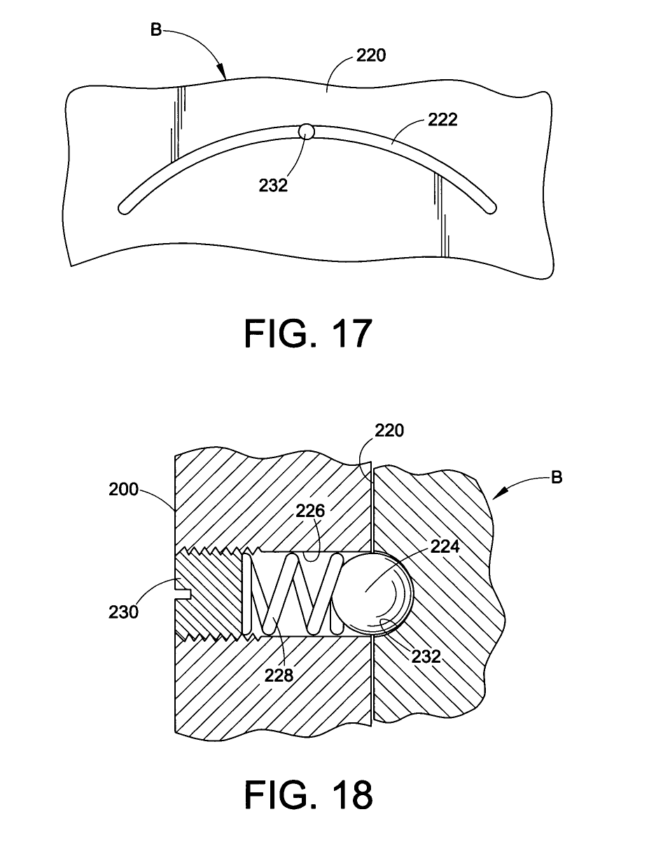

FIGS. 13-18 show another arrangement, and parts that generally correspond to the same parts in FIGS. 1-12 are identified by the same reference numbers that are primed.

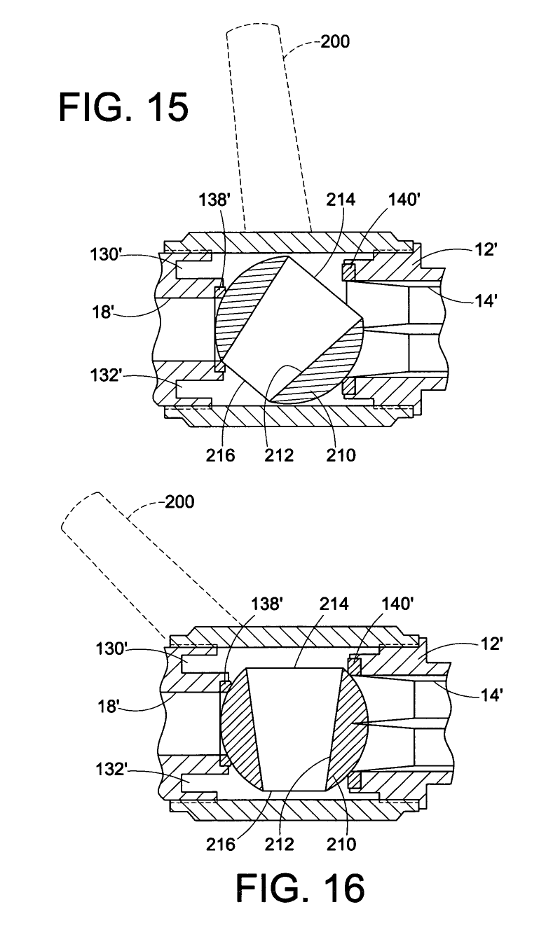

Inverted generally U-shaped handle 200 is attached to opposite sides of nozzle body B′ by fasteners 202 for forward and backward movement from the solid line position of FIGS. 13 and 15 to the shadow line positions of FIGS. 14 and 16.

Valve ball 210 is attached for movement with handle 200 as generally described with reference to FIGS. 1-12. Valve ball 210 has a single central passage 212 therethrough between a large diameter ball inlet 214 and a smaller diameter ball outlet 216. Thus, ball passage 212 is frusto-conical from ball inlet 214 to ball outlet 216.

Handle 200 is moved full rearward to the position of FIG. 14 to provide solid stream discharge wherein the longitudinal axes of inlet or supply passage 14′, ball passage 212 and outlet passage 18′ are generally coincidental. Liquid then flows exclusively through solid stream sleeve 26′.

In the full forward position of FIG. 16, valve ball 210 cooperates with seal 140′ to close inlet or supply passage 14′ and no water flows through nozzle A′. In the arrangement shown, lateral bypass openings 142 in inlet adapter 12 of FIG. 1 are omitted from inlet adapter 12′ of FIGS. 13-18 so that no liquid at all can bypass ball 210 in the position of FIG. 16.

With handle 200 in the position of FIG. 15, valve ball 210 is positioned in cooperative relationship with seal 138′ to close discharge passage 18′, while inlet opening 214 of ball passage 212 is positioned to receive liquid from inlet or supply passage 14′, and ball passage outlet opening 216 is positioned to discharge liquid to internal flow passages 130′, 132′ for discharge through annular flow passage 50′ in a fog pattern.

Nozzle body B′ has opposite flat surfaces, only one of which is shown at 220 in FIGS. 13, 17 and 18. An arcuate groove 222 in the flat surfaces receives a ball 224 that is received in a bore 226 in handle 220. A coil spring 228 positioned between ball 224 and a screw 230 biases ball 224 toward arcuate groove 222.

A circular recess or detent 232 intermediate the opposite ends of arcuate groove 222 provides a releasable stop for locating handle 200 in its intermediate full line position of FIGS. 13 and 15 with valve ball 210 located for supplying liquid exclusively to annular fog liquid flow passage 50′. Force applied to handle 200 in either direction causes ball 224 of FIG. 18 to cam out of circular detent 232 for movement along arcuate groove 222 to the positions of either FIGS. 14 or 16.

As shown in FIGS. 14-16, supply passage 14′ at the interface thereof with ball 210 is larger than discharge passage 18′ at the interface thereof with ball 210. Thus, ball inlet 214 is generally the same size as the mating opening in supply passage 14′, and ball outlet 216 is generally the same size as the mating opening in discharge passage 18′.

Although the invention has been shown and described with reference to representative embodiments, it is obvious that alterations and modifications will occur to others skilled in the art upon the reading and understanding of this application. Therefore, it is to be understood that the invention may be practiced otherwise than as specifically described herein while remaining within the scope of the claims.

1. A firefighting nozzle comprising:
a nozzle body having a ball valve with upstream and downstream sides;
a liquid supply passage on said upstream side of said valve;
solid stream and annular discharge passages on said downstream side of said valve;
said ball valve having a ball with a ball passageway that is configured to provide flow therethrough from said supply passage to said annular discharge passage in one position of said ball in which said solid stream discharge passage is closed by said ball and to provide flow therethrough from said supply passage to said solid stream discharge passage in another position of said ball; and
said ball passageway being a single passageway that is centrally located in said ball.

2. The nozzle of claim 1 wherein said ball passageway and said supply and solid stream discharge passages have generally coincidental axes in said other position of said ball.

3. The nozzle of claim 1 wherein said ball passageway is generally frusto-conical.

4. The nozzle of claim 1 including upstream and downstream seals positioned between said ball and said supply and discharge passages.

5. The nozzle of claim 1 wherein said annular discharge passage surrounds said solid stream discharge passage.

6. The nozzle of claim 1 wherein said ball passageway has a ball passageway inlet and a ball passageway outlet, and said ball passageway inlet is larger than said ball passageway outlet.

7. The nozzle of claim 6 wherein said supply passage at the interface thereof with said ball is larger than said discharge passage at the interface thereof with said ball.

8. A firefighting nozzle comprising:
a nozzle body having a ball valve with upstream and downstream sides;
a liquid supply passage on said upstream side of said valve;
solid stream and annular discharge passages on said downstream side of said valve;
said ball valve having a ball with a ball passageway that is configured to provide flow therethrough from said supply passage to said annular discharge passage in one position of said ball in which said solid stream discharge passage is closed by said ball and to provide flow therethrough from said supply passage to said solid stream discharge passage in another position of said ball;
said ball passageway being frusto-conical and being centrally located in said ball; and
said ball passageway and said supply and solid stream discharge passages having generally coincidental longitudinal axes in said other position of said ball.

9. The nozzle of claim 8 including upstream and downstream seals positioned between said ball and said supply and discharge passages.
